(19) United States
(12) Patent Application Publication
(10) Pub. No.: US 2015/0180038 A1
(43) Pub. Date: Jun. 25, 2015

(54) Bipolar Li-Ion Battery with Improved Seal and Associated Production Process

(71) Applicant: COMMISSARIAT A L'ENERGIE ATOMIQUE ET AUX ENERGIES ALTERNATIVES, pARIS (FR)

(72) Inventors: Jean-Francois Damlencourt, Laval (FR); Emmanuel Augendre, Montbonnot (FR); Frank Fournel, Villard-bonnot (FR)

(73) Assignee: COMMISSARIAT A L'ENERGIE ATOMIQUE ET AUX ENERGIES ALTERNATIVES, Paris (FR)

(21) Appl. No.: 14/415,472

(22) PCT Filed: Jul. 3, 2013
(86) PCT No.: PCT/IB2013/055443

§ 371 Date: Jan. 16, 2015

(30) Foreign Application Priority Data
Jul. 17, 2012 (FR) 1256907

(51) Int. Cl. H01M 4/64; H01M 10/04; H01M 4/58; H01M 10/0525; H01M 2/02; H01M 4/485

(52) U.S. Cl. CPC H01M 4/64; H01M 2/0257; H01M 4/485; H01M 4/5825; H01M 10/0525; H01M 2/026; H01M 2/0262; H01M 10/04; H01M 2004/029

(57) ABSTRACT

The present invention relates to a bipolar battery comprising at least two electrochemical cells (C1, C2) stacked on top of one another, each collector (13, 21) comprising on its periphery at least one bead (23) of an electrically insulating material also forming a peripheral zone of the wall impermeable to the electrolyte. According to the invention, each impermeable wall is obtained by a technique chosen from direct bonding, anodic bonding between a bead of the bipolar collector and the bead of the adjacent collector, and eutectic bonding between a layer made of metal or a eutectic metal alloy deposited on a bead of the bipolar collector and a layer made of metal or eutectic metal alloy deposited on a bead of the adjacent collector.

### TECHNICAL FIELD

The present invention relates to the field of lithium electrochemical generators, which operate on the principle of insertion or disinsertion, otherwise known as intercalation-deintercalation, of lithium in at least one electrode.

It relates more particularly to a lithium electrochemical accumulator comprising at least one bipolar current collector, also called a bipolar battery. In such a bipolar battery, the bipolar collector, also called a bipolar electrode, supports on each of the opposing faces thereof one of the two electrode materials opposite in sign, i.e. with a cathode (positive electrode) supported by the one of the faces and an anode (negative electrode) supported by the other of the opposing faces.

The invention is aimed at improving the seal of electrochemical generators with respect to the electrolyte, and in particular at improving the seal of a bipolar battery with respect to the electrolyte in liquid form.

### PRIOR ART

The architecture of conventional lithium-ion batteries is an architecture that may be termed monopolar, since with a single electrochemical cell comprising an anode, a cathode and an electrolyte. Several types of monopolar architectural geometry are known:
a cylindrical geometry as disclosed in patent application US 2006/0121348,
a prismatic geometry as disclosed in U.S. Pat. Nos. 7,348,098 and 7,338,733;
a stacking geometry as disclosed in patent applications US 2008/060189, US 2008/0057392 and U.S. Pat. No. 7,335,448.

A monopolar architecture is produced by winding. The winding consists of a current collector on which a positive electrode material (cathode) is continuously deposited, a separator made of polymer or ceramic material being intercalated with a negative electrode material (anode) itself deposited on another current collector. This monopolar architecture has the main advantage of having a large active surface of material but the potential difference is restricted to the unit value of the potential difference between the two electrode materials used, which is also the case of stacking geometry.

In order to increase the average potential of a monopolar Li-ion battery while preserving a comparable energy density, it is known to produce a battery with a plurality of electrochemical cells in series. The architecture of the battery is thus termed bipolar since it includes a cathode of one cell and an anode of an adjacent cell which are supported on the same current collector in the form of a plate, itself termed a bipolar electrode. The architecture of a bipolar battery thus corresponds to the series connection of multiple monopolar accumulators via bipolar electrodes or current collectors, but with the advantage of having a low electrical resistance compared with monopolar accumulators connected in series by external connectors. Numerous patent applications or patents relating to such bipolar batteries may be cited here, such as U.S. Pat. No. 7,279,248, U.S. Pat. No. 7,220,516, U.S. Pat. No. 7,320,846, U.S. Pat. No. 7,163,765, WO 03/047021, WO 2006/061696 and U.S. Pat. No. 7,097,937.

The subsequent advantages of a bipolar battery are those of having a reduced mass and not comprising unnecessary volumes.

The main difficulty in designing a bipolar battery is the production of compartments that are perfectly impermeable to the electrolyte, generally in liquid form, with respect to each other. Indeed, a poor seal causes malfunctioning of the bipolar battery via ionic short circuits.

This is further corroborated by the fact that most of the patent literature dealing with the field of bipolar Li-ion batteries concerns sealing or sealant solutions, for preventing electrolyte leakage from one compartment to the other (ionic short circuits). Whichever sealing system is adopted, it must:
be chemically resistant to the liquid electrolyte, e.g. consisting of a solution of lithium salt LiPF₆ in a solvent mixture of ethylene carbonate (EC), and dimethyl carbonate (DMC);
be easy to implement: indeed, during the operations of stacking the various elements forming a bipolar battery, the implementation of the seal must be able to be compatible with an industrial production line and be performed at relatively low temperatures generating little or no degradation of the electrodes, the separator or the electrolyte;
ensure a total long-term seal.

Among the patent applications or patents already mentioned above, U.S. Pat. No. 7,220,516 may be cited which describes a solution with a flexible adhesive film 5, 6, stuck onto the periphery of the bipolar collector.

U.S. Pat. No. 7,320 846 may also be cited which describes a solution of coating the collectors 4 and electrolytes 6 in a resin 10.

U.S. Pat. No. 7,163,765 may also be cited describing a sealing solution with mixed polyamide/PP sealing layers 9 arranged between bipolar collectors, the polyamide being welded directly to the periphery of the collectors away from the cells.

U.S. Pat. No. 7,097,937 provides a double sealing solution, since a fluoropolymer inner barrier 14, 22 is arranged on the periphery of the bipolar collector 11 and an elastomer outer frame 18, 23 is arranged on the outside of the barrier 14, 22 on and around the bipolar collector optionally with the arrangement of an additional elastomer ring 15 on the collector 11.

Patent application EP 2073300 on behalf of the applicant may further be cited, which provides a solution according to which the dimensions of the plates are increased one with respect to the adjacent other and the sealing joints interposed between the interconnecting plates are offset transversely so that two joints are not located opposite each other along the stacking axis of the cells.

Finally, WO 2011/157751 may be cited, which describes a solution of integrating polymer-based sealing means with a metal grate or sheet acting as a current collector.

Thus, the solutions already envisaged for improving the seal between compartments with respect to the electrolyte in a bipolar Li-ion battery may be summarized as follows:
systematic embodiment of the bipolar current collector, also called a bipolar electrode, in the form of a plate,
use of various glues/polymers or resins at the periphery of the plate,
increase in the format of the bipolar current collector plate for creating an additional barrier to the electrolyte;
integrating polymer-based sealing means with a metal grate or sheet acting as a current collector.

All these sealing solutions already considered not completely satisfactory. Indeed they all use polymers or resins which display a robustness with respect to the electrolyte which is low during the operation of the bipolar battery and in duration. In addition, the implementation of solutions with polymers is tricky since these have a tendency to flow beyond a certain temperature, which is certainly not expected to be reached during battery operation, but may be in case of runaway. Finally, the heat sealing of a polymer in a compartment provided during the manufacture of the bipolar battery may lead to a deterioration in the seal of electrochemical compartments already sealed due to the very fact of repeated heating, which may cause unwanted flow of the polymer thereof.

The general aim of the invention is to provide a solution other than those already envisaged for improving the seal of the compartments therebetween with respect to the electrolyte, in particular of the liquid electrolyte, in a bipolar Li-ion battery, more generally in a lithium electrochemical generator.

A particular aim is to provide a solution for sealing a bipolar battery, more generally of a lithium electrochemical generator, with respect to the electrolyte, more particularly a liquid electrolyte, which is robust in operation and in duration and easy to implement, preferably at a relatively low temperature.

### SUMMARY OF THE INVENTION

To do this, the subject matter of the invention is a Li-ion type bipolar battery, including:
at least a first and second electrochemical cell stacked one on top of the other and each comprising an anode, a cathode and an electrolyte,
at least one bipolar current collector, one face of which is covered by the anode made of lithium insertion material of the first cell and the opposite face is covered by the cathode made of lithium insertion material of the second cell, the bipolar collector comprising at the periphery thereof, on each of the faces thereof, at least one bead of an electrically insulating material forming a peripheral zone of a wall impermeable to the electrolyte of the first or second cells, surrounding same,
at least one first current collector adjacent to the bipolar collector, one face of which is covered by the cathode of the first cell; the first adjacent collector also comprising at the periphery thereof at least one bead of an electrically insulating material also forming a peripheral zone of a wall impermeable to the electrolyte of the first cell,
at least one second current collector adjacent to the bipolar collector, one face of which is covered by the anode of the second cell; the second adjacent collector also comprising at the periphery thereof at least one bead of an electrically insulating material also forming a peripheral zone of a wall impermeable to the electrolyte of the second cell.

According to the invention, each impermeable wall is obtained by a technique selected from molecular bonding, anodic sealing between a bead of the bipolar collector and the bead of the adjacent collector, and eutectic melting between a layer made of eutectic point metal or metal alloy deposited on a bead of the bipolar collector and a layer made of eutectic point metal or metal alloy deposited on a bead of the adjacent collector.

Thus, a first alternative of the invention is characterized in that each impermeable wall is obtained by molecular bonding between a bead of the bipolar collector and the bead of the adjacent collector.

‘Molecular bonding’, here and in the context of the invention, is understood to mean molecular adhesion through direct contact of two beads, i.e. without the use of a specific intermediate material for achieving adhesion, such as a glue, polymer or metal with a low melting temperature. Reference may be made to the publication [1] detailing the implementation of this technique in the field of microelectronics.

The invention remedies resin- or polymer-based sealing solutions according to the prior art. Indeed, first of all, molecular bonding is implemented in a controlled way. An initial bonding is carried out via van der Waals-type bonds solely by being placed in direct contact with the beads, advantageously at ambient temperature. Then, the final molecular bonding is carried out via strong covalent-type molecular bonds by heating at a relatively low temperature, typically less than or equal to 200° C., preferably between 100 and 200° C., for approximately one hour. Once this final molecular bonding has been implemented for an electrochemical compartment, there is no longer any risk of the impermeable wall being modified even in the event of heating other compartments of the battery or heating of same, particularly when it is capable of operating in a degraded mode (temperature above the nominal operating temperature). In addition, unlike sealing solutions incorporating polymers, molecular bonding will be strengthened by heating of the battery.

The constituent electrically insulating materials of the beads according to the invention are solids, which enables a thickness to be preserved for each electrochemical compartment of the battery. The chosen insulating material or materials display(s) a high chemical resistance to the electrolyte and a resistance to high operating temperatures.

Preferably, according to this first alternative, the material of each bead is aluminum oxide (Al₂O₃), also known as alumina.

The inventors believe first that this material is a very good electrical insulator for the intended bipolar battery application according the invention.

Secondly, alumina may be easily deposited in the form of a thin layer on the constituent metal material of a current collector of a bipolar battery. Thus, for an aluminum current collector, a corona treatment, which consists in performing a high-frequency electrical discharge toward the material, here the metal material, provides the surface with a thin layer of alumina. This surface alumina layer itself serves as a seed layer for the alumina layer that constitutes a deposited bead. The corona treatment is an oxidizing treatment preferably performed under ultraviolet (UV) and under oxygen O₂.

Once an alumina bead is deposited, a functionalization is preferably performed, e.g. by a treatment with a mixture of water, hydrogen peroxide and dilute ammonia (5:1:1) in order to obtain Al—OH bonds at the surface of the beads. Thus, placing two beads in contact with Al—OH bonds produces an initial bonding by hydrogen bonds, which are among the most energetic bonds of the van der Waals bonds, preferably at ambient temperature.

The final molecular bonding between two beads is achieved by heating to a higher temperature, preferably equal to 200° C.

A second alternative of the invention is characterized in that each impermeable wall is obtained by anodic sealing between a bead of the bipolar collector and the bead of the adjacent collector. Preferably, according to this second alternative, the material of each bead is a metal oxide doped with boron, e.g. alumina or silicon dioxide SiO₂ doped with boron or B-doped ZrO₂.

‘Anodic sealing’, here and in the context of the invention, is understood to mean a bonding which consists of placing two beads in contact at high temperature, typically between 300° C. and 400° C., then applying a potential difference of several hundred volts therebetween. Here the migration of boron dopants up to the interface provides an electrostatic bonding of great strength. Reference may be made to the publication [2] detailing the implementation of this technique.

In this second alternative of the invention, it is the diffusion of ions, preferably the boron dopants of the beads in contact, which enables strong molecular bonds to be obtained.

A third alternative of the invention is characterized in that each bead is coated with a layer of eutectic point metal or metal alloy, and each impermeable wall is obtained by eutectic melting between the bead layer of the bipolar collector and the bead layer of the adjacent collector.

‘Eutectic melting’, here and in the context of the invention, is understood to mean a melting at the eutectic point of the metal or metal alloy layers applied one on top of the other by thermocompression.

This third alternative is selected in preference to the first alternative, when the roughness and flatness conditions of the beads do not allow molecular bonding to be achieved. Thus, for example, when the current collector is rough, typically with a roughness greater than 0.5 nm, or when there is a lack of flatness, depositing a metal layer on the bead is preferred. Preferably, according to this third alternative, the material of each bead is made of aluminum oxide (Al₂O₃) and the material of one layer is aluminum Al and germanium for the other layer, i.e. for the layer deposited on the adjacent bead. Alternatively, there may be a silicon layer facing a gold layer for forming a eutectic alloy Si/Au. Thus, a eutectic melting of the aluminum layers is created therebetween, the alumina Al₂O₃ enabling the electrical insulation between two adjacent current collectors to be preserved.

‘Electrode made of lithium insertion material’ here and in the context of the invention is understood to mean an electrode comprising at least one lithium insertion material and at least one polymer binder. Optionally, the electrode may further comprise an electronic conductor, e.g. carbon fibers or carbon black.

‘Lithium insertion material’, in particular for the positive electrode, here and in the context of the invention, is understood to mean a material selected from the lithiated oxides including manganese with a spinel structure, lithiated oxides with a lamellar structure and mixtures thereof, lithiated oxides with polyanionic frameworks of the formula LiM_{y}(XO_{z}) with M representing an element selected from Mn, Fe, Co, Ni, Cu, Mg, Zn, V, Ca, Sr, Ba, Ti, Al, Si, B and Mo, X representing an element selected from P, Si, Ge, S and As, y, z and n being positive integers.

‘Lithium insertion material’, in particular for the negative electrode, is also understood to mean a material selected from: lithiated or non-lithiated titanium oxide, e.g. Li₄Ti₅O₁₂ or TiO₂. More particularly, the negative electrode material may be selected from carbonaceous materials, non-lithiated titanium oxides and their derivatives and lithiated titanium oxides such as Li₄Ti₅O₁₂ and the derivatives thereof and a mixture of same.

‘Lithiated derivative’, here and in the context of the invention, is understood to mean compounds of formula Li₍₄₋ₓ₁₎Mₓ₁Ti₅O₁₂ and Li₄Ti_{(5-y1})N_{yl}O₁₂ where x1 and y1 are respectively between 0 and 0.2 and M and N are respectively chemical elements selected from Na, K, Mg, Nb, Al, Ni, Co, Zr, Cr, Mn, Fe, Cu, Zn, Si and Mo.

‘Non-lithiated derivative’, here and in the context of the invention, is understood to mean Ti_{(5-y1)}N_{y1}O₁₂, with y1 between 0 and 0.2 and N is a chemical element selected from Na, K, Mg, Nb, Al, Ni, Co, Zr, Cr, Mn, Fe, Cu, Zn, Si and Mo.

‘Current collector adjacent to the bipolar current collector’ is understood to mean a collector that is closest to the bipolar current collector in the stack and which may be either another bipolar current collector or a terminal current collector of the stack.

Preferably, the thickness of each bead is substantially equal to the thickness of an electrode on the same face of a collector.

Again preferably, the thickness of each bead is between 20 and 70 μm, preferably 50 μm plus or minus 5 82 m.

Advantageously, the width of each bead is between 0.1 and 2 cm.

According to one embodiment, the bipolar battery includes a stack of n electrochemical cells, with a number of n-2 bipolar current collectors, one of the adjacent collectors being a terminal current collector, the other of the adjacent collectors being the other terminal current collector.

According to one variant embodiment, all the anodes are made of Li₄Ti₅O₁₂ and the cathodes of LiFePO₄.

The subject matter of the invention, in another of the aspects thereof, is also a process for the production of a bipolar battery including at least a first and second electrochemical cell stacked one on top of the other and each comprising an anode, a cathode and an electrolyte,
a/ production of a bipolar current collector with one face covered by the anode made of lithium insertion material of the first cell and the opposite face covered by the cathode made of lithium insertion material of the second cell;
b/ production of a first current collector, intended to be adjacent to the bipolar collector, one face of which is covered by the cathode of the first cell;
c/ production of a second current collector, intended to be adjacent to the bipolar collector, one face of which is covered by the anode of the second cell;
d/ deposition of a bead made of electrically insulating material at the periphery of each face of each collector covered by a cathode or by an anode;
e/ stacking of three collectors with intercalation of a separator between two adjacent collectors, the stacking with intercalation being performed so that:
   the cathode of the adjacent first collector is facing the anode of the bipolar collector, being separate from a first separator and with the beads thereof being placed in contact;
   the anode of the adjacent second collector is facing the cathode of the bipolar collector, being separate from a second separator and with the beads thereof being placed in contact;
f/ heating of the beads in contact at the periphery of the collectors, the separators each being impregnated with an electrolyte.

‘Separator’, here and in the context of the invention, is understood to mean an electrical insulator, ionic conductor formed by at least one polymer material such as polyvinylidene fluoride (PVDF), polyvinyl acetate (PVA), polymethylmethacrylate (PMMA), polyethylene oxide (PEO), polyethylene terephthalate (PET), or a polymer selected from the polyolefins such as polypropylene, polyethylene or cellulose.

The electrolyte according to the invention may be a liquid formed of a mixture of carbonate and at least one lithium salt. ‘Lithium salt’ is preferably understood to mean a salt selected from LiPF6, LiClO4, LiBF4 and LiAsF6.

Alternatively, the electrolyte may include one or more lithium-ion-based ionic liquids, namely a salt consisting of lithium cations, complexed with inorganic or organic anions, which has the property of being in liquid state at ambient temperature. An ionic liquid, according to the nature of the anion, may be hydrophilic or hydrophobic. Examples of ionic liquids include hydrophobic anion-based ionic liquids like trifluoromethanesulfonate (CF₃SO₃), bis(trifluoromethylsulfonyl)imide [(CF₃SO₂)₂N] and tris((trifluoromethyl)sulfonyl)methanide [(CF₃SO₂)₃C].

The heating according to step f/ is preferably carried out using U-shaped heating jaws around the peripheral portions of the collectors.

Placing the beads in contact in step e/ is preferably carried out at ambient temperature.

### DETAILED DESCRIPTION

Other advantages and features will better emerge on reading the detailed description, given by way of illustration with reference to the following figures in which:

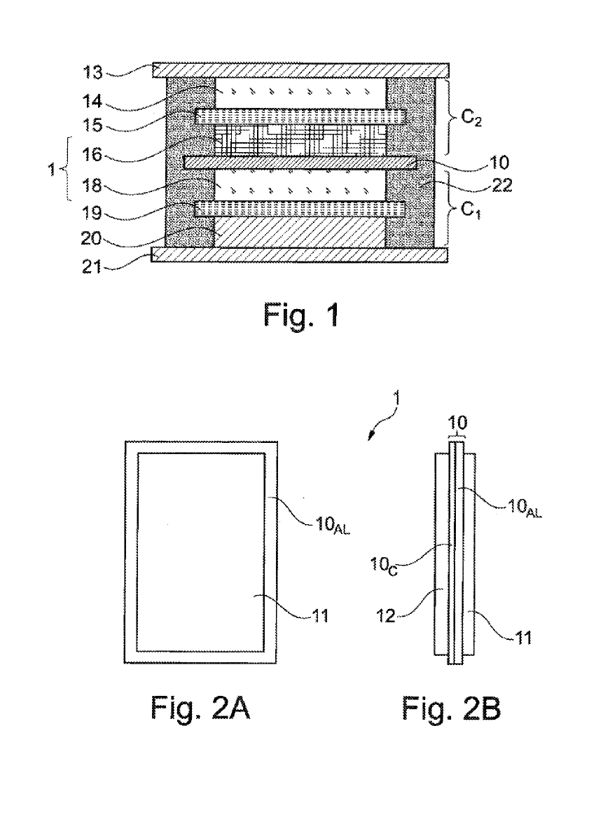

FIG. 1 is a schematic longitudinal sectional view of a bipolar lithium battery according to the prior art,

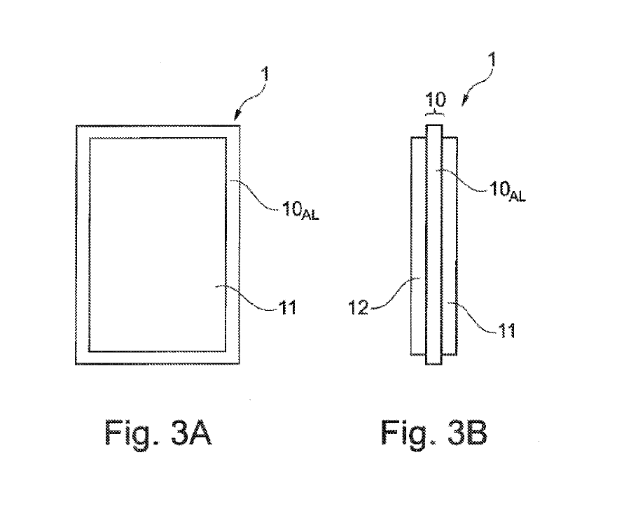

FIGS. 2A and 2B are respectively front and sectional views of a bipolar current collector used in a bipolar lithium battery according to the prior art,

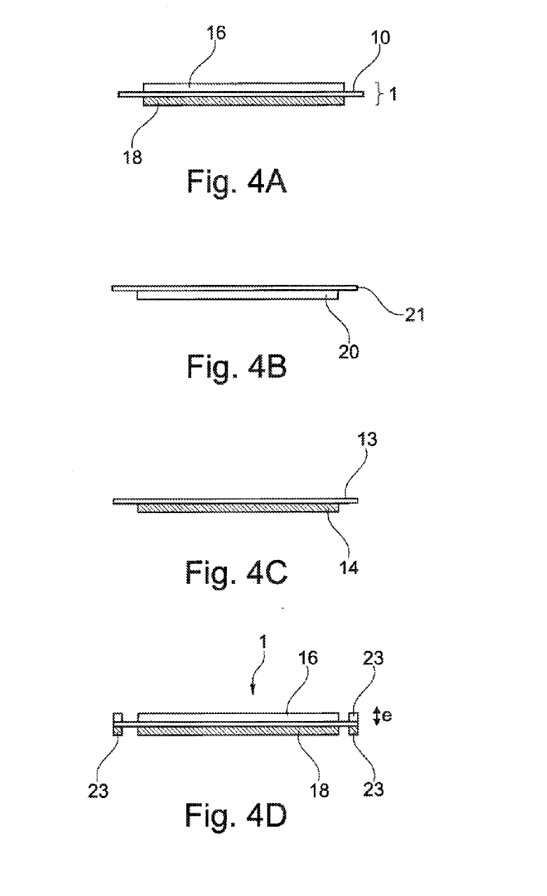

FIGS. 3A and 3B are respectively front and sectional views of another bipolar current collector used in a bipolar lithium battery according to the prior art,

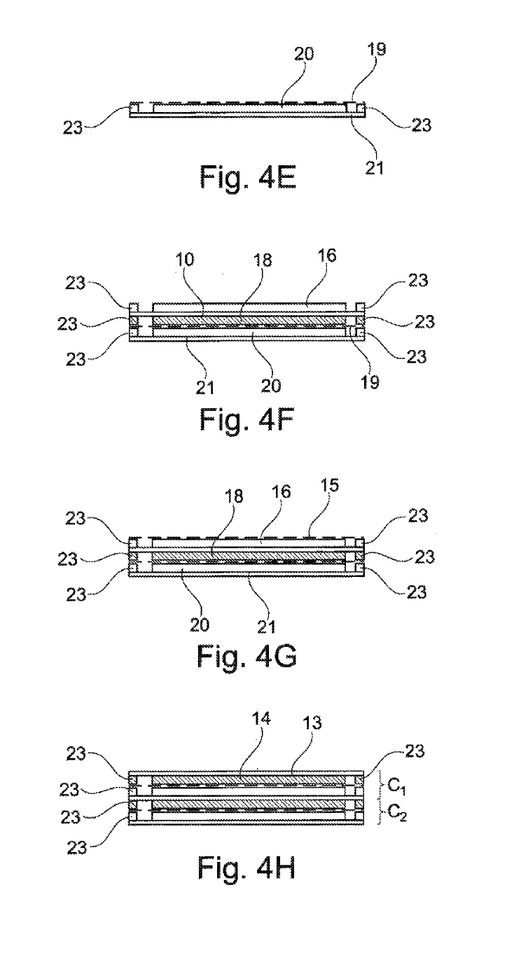

FIGS. 4A to 4H are longitudinal sectional views depicting the various steps of producing a bipolar lithium battery according to the invention,

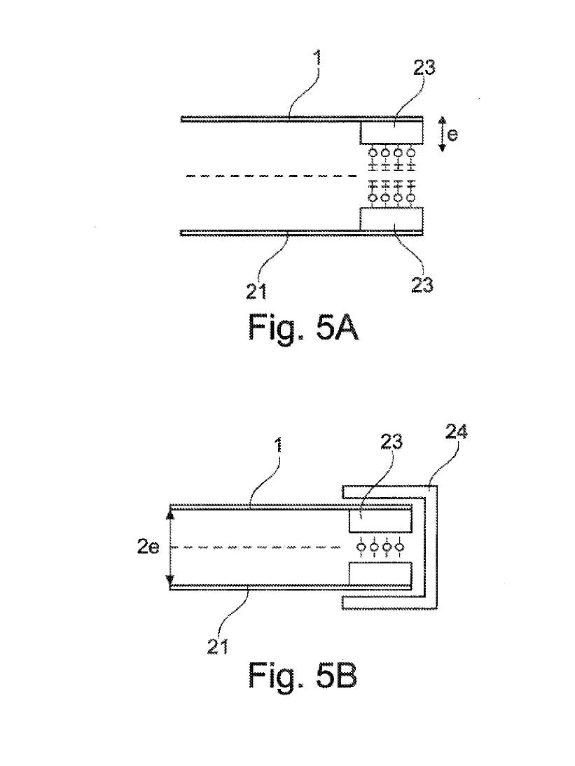

FIGS. 5A and 5B are detail views depicting the molecular bonding performed in the steps represented in FIGS. 4F and 4H;

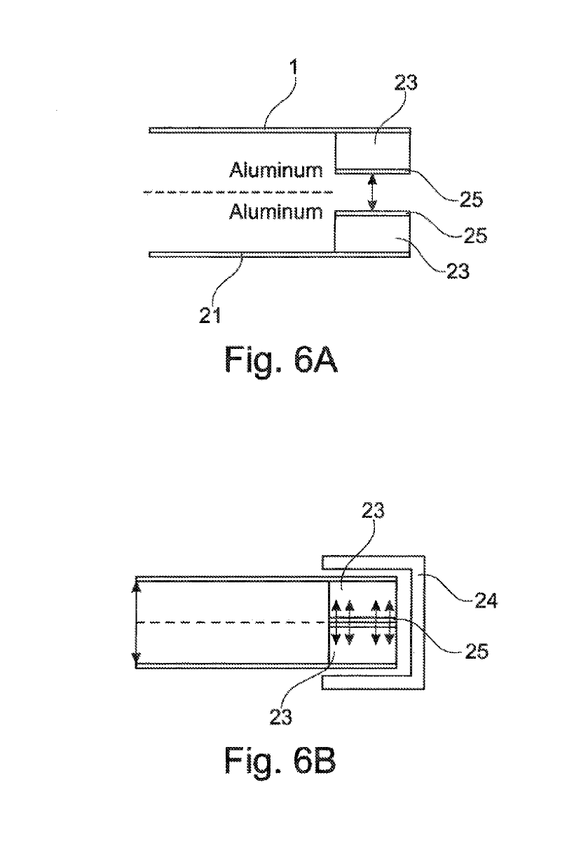

FIGS. 6A and 6B are detail views depicting another alternative embodiment of the seal as depicted in FIGS. 5A and 5B.

For the sake of clarity, the same references designating the same bipolar battery elements according to the prior art and according to the invention are used for all the FIGS. 1 to 6B.

A bipolar Li-ion battery according to the prior art is represented in FIG. 1, as illustrated in patent application WO 03/047021. This battery comprises in the upper portion an aluminum conductive substrate 13 (current collector positive terminal) and an active layer 14 based on positive lithium insertion material, such as Li_{1.04}Mn_{1.96}O₄, and in the lower portion an aluminum conductive substrate 21 (negative terminal current collector) and an active layer 20 based on positive lithium insertion material, such as Li₄Ti₅O₁₂.

Within this battery, a bipolar electrode 1, also called a bipolar current collector, includes an anode layer 16 and a cathode layer 18 on each side of an aluminum conductive substrate 10 in the form of a plate. The lower 20 and upper 14 electrodes are separated from the bipolar electrode 1 by two separators 15, 19 wherein an electrolyte is present in liquid or gel form. The seal for the battery electrolytes between the two adjacent electrochemical cells formed 14, 15, 16 and 18, 19, 20 is provided by a joint 22 which is created by a resin or adhesive deposit on the periphery of all the electrodes and the plate 10.

A bipolar current collector 10 according to the prior art, according to the lithium ion insertion materials used for producing the electrodes:
either consists of two superimposed plates, of which one typically made of aluminum 10Al is covered by a cathode 11 and the other typically made of copper 10C is covered by an anode 12 (FIGS. 2A and 2B),
or consists of a single plate typically made of aluminum 10A1 covered on one of the faces by a cathode 11 and on the other of the faces thereof by an anode 12 (FIGS. 3A and 3B). The main difficulty encountered in the design of a bipolar battery according to the prior art is the production of compartments that are perfectly impermeable to the electrolyte, generally in liquid form, with respect to each other, such as between the two cells C1 and C2, i.e. between compartments referenced 14, 15, 16 and 18, 19, 20 in FIG. 1.

The implementation of the joints 22 or the increase in the plates 10 of the bipolar electrode according to the prior art for achieving this are not fully satisfactory.

Consequently, the inventors provide a new solution for sealing a bipolar Li-ion battery with respect to the electrolyte, more particularly a liquid electrolyte, which is robust in operation and in duration and easy to implement, preferably at relatively low temperature.

Surprisingly, the inventors thought of implementing a molecular bonding technique for making sealing joints in a bipolar battery. This molecular bonding technique has certainly already proven itself in the field of microelectronics, but in this field it involves making two substrate surfaces adhere together directly. In other words, in this field, it means assembling two substrates together, and there was no evidence for using this molecular bonding technique for making a joint by first adding beads made of electrically insulating material onto a collector surface made of conductive material.

The steps of producing a bipolar battery with sealing means by molecular bonding according to the invention are described below in relation to FIGS. 4A to 4B.

The battery produced comprises two cells C1, C2 stacked one on top of the other and each comprising an anode, a cathode and an electrolyte. It is specified that all the substrates 10, 13, 21 are made of aluminum. All the anodes of Li₄Ti₅O₁₂ and all the cathodes of LiFePO₄. The separators are all made of the same material such as polyvinylidene fluoride (PVDF). The electrolyte used is a mixture of carbonate and a lithium salt LiPF₆.

It is specified that all the steps 1 to 6 are performed at ambient temperature.

Step 1: a bipolar current collector 1 is produced with one face covered by the cathode 18 of the first cell C1 and the opposite face covered by the anode 16 of the second cell C2 (FIG. 4A).

Step 2: a current collector 21 is produced with one face covered by the anode 20 of the first cell C1 (FIG. 4B).

Step 3: a terminal current collector 13 is produced with one face covered by the cathode 18 of the second cell C2 (FIG. 4C).

Step 4: a bead 23 made of electrically insulating material is deposited at the periphery of each face of each collector covered by a cathode 14 or 18 or by an anode 16 or 20. All the beads 23 are made of electrical insulating material which is preferably aluminum oxide, deposited in the form of a thin layer with thickness e of the order of 50 μm. In FIG. 4D, the bipolar current collector 1 is represented with a bead 23 made of alumina at the periphery thereof on each of the two faces of same.

Step 5: A first separator 19 is intercalated by laying same on the anode 20 of the first terminal current collector 21 (FIG. 4E).

The bipolar current collector 1 is stacked on the first terminal collector 21 placing the beads 23 thereof in direct contact (FIG. 4F). This placing in direct contact produces an initial bonding between the beads 23 via weak electrostatic hydrogen bonds.

Step 6: The second first separator 15 is intercalated by laying same on the anode 16 of the bipolar current collector 1 (FIG. 4G).

The second terminal current collector 13 is stacked on the bipolar collector 1 placing the beads thereof in direct contact (FIG. 4H). This placing in direct contact produces an initial bonding between the beads 23 via weak hydrogen bonds.

Step 7: Heating is carried out using U-shaped heating jaws surrounding the stack of the bipolar battery with two cells C1, C2 at the periphery thereof. This heating is used to convert the weak hydrogen bonds made between beads 23 into covalent bonds.

The seal thus obtained by all the beads 23 is thus perfect with respect to the electrolyte.

FIGS. 5A and 5B represent the various steps of molecular bonding between the first terminal collector 21 and the bipolar collector:
when the beads 23 of alumina Al₂O₃ are placed in direct contact, weak hydrogen bonds are created (FIG. 5A);
during heating using U-shaped jaws 24 surrounding the stack, strong covalent bonds are created between beads 23 previously in direct contact (FIG. 5B).

According to another alternative of the invention, in particular when the aluminum substrates of the current collectors are rough or display a lack of flatness, eutectic melting is possible between two layers of germanium and aluminum 25 (FIG. 6B), these layers 25 being previously deposited on each bead 23 made of alumina Al₂O₃ (FIG. 6A).

With regard to the electrolytes, an electrolyte may be used in polymer form or in impregnated liquid form in a separator. For activating the latter, each separator may be impregnated before the integration of same during assembly. Alternatively, the assembly may be carried out with stacking of the whole battery, the seal produced according to the invention, then an entry made for the liquid electrolyte for subsequent filling via a pipe arranged between the two beads.

The invention is not limited to the examples that have just been described; features of the illustrated examples may in particular be combined together within variants not illustrated.

It goes without saying that while the seal according to the invention by molecular bonding has been described in connection with a bipolar battery with two stacked cells, it may be implemented in the same way for a battery with a number n of stacked cells by repeating the preceding steps 1 to 7 with a number equal to n-2 of bipolar collectors and two terminal current collectors 13, 21.

### REFERENCES CITED

### [1]: M. Bruel, Electronic Letter, 31 (14), p.1201, 1995;

[2]: G .Wallis and D. Pomerantz, Journal of Applied Physics 40 (10) pp 3946-3949.

1.-12. (canceled)

13. A bipolar Li-ion battery, including:
at least a first and second electrochemical cells stacked one on top of the other and each comprising an anode, a cathode and an electrolyte;
at least one bipolar current collector one face of which is covered by the anode made of lithium insertion material of the first cell and the opposite face is covered by the cathode made of lithium insertion material of the second cell, the bipolar collector comprising at the periphery thereof, on each of the faces thereof, at least one bead of an electrically insulating material forming a peripheral zone of a wall impermeable to the electrolyte of the first or second cells, surrounding same;
at least one first current collector adjacent to the bipolar collector one face of which is covered by the cathode of the first cell; the first adjacent collector also comprising at the periphery thereof, at least one bead of an electrically insulating material also forming a peripheral zone of a wall impermeable to the electrolyte of the first cell;
at least one second current collector adjacent to the bipolar collector one face of which is covered by the anode of the second cell; the second adjacent collector also comprising at the periphery thereof, at least one bead of an electrically insulating material also forming a peripheral zone of the wall impermeable to the electrolyte of the second cell;
each impermeable wall being obtained by a technique selected from molecular bonding, anodic sealing between a bead of the bipolar collector and the bead of the adjacent collector, and eutectic melting between a layer of eutectic point metal or metal alloy deposited on a bead of the bipolar collector and a layer of eutectic point metal or metal alloy deposited on a bead of the adjacent collector.

14. The bipolar battery as claimed in claim 13, each impermeable wall being obtained by molecular bonding, the material of each bead being made of aluminum oxide.

15. The bipolar battery as claimed in claim 13, each impermeable wall being obtained by anodic sealing, the material of each bead being made of silicon dioxide SiO₂ doped with boron.

16. The bipolar battery as claimed in claim 13, each impermeable wall being obtained by eutectic melting, the material of each bead being made of aluminum oxide and the material of a layer deposited on a bead being made of aluminum and germanium for the layer deposited on the adjacent bead.

17. The bipolar battery as claimed in claim 13, the thickness f each bead being substantially equal to the thickness of an electrode on the same face of a collector.

18. The bipolar battery as claimed in claim 13, the thickness of each bead being between 20 and 70 μm.

19. The bipolar battery as claimed in claim 18, the thickness of each bead being 50 pm plus or minus 5 μm.

20. The bipolar battery as claimed in claim 13, the width of each bead being between 0.1 and 2 cm.

21. The bipolar battery as claimed in claim 13, including a stack of n electrochemical cells, with a number of n-2 bipolar current collectors, one of the adjacent collectors being a terminal current collector, the other of the adjacent collectors being the other terminal current collector.

22. The bipolar battery as claimed in claim 13, wherein the anodes are made of Li₄Ti₅O₁₂ and the cathodes of LiFePO₄.

23. A bipolar battery production process including at least first and second electrochemical cells stacked one on top of the other and each comprising an anode, a cathode and an electrolyte,
a/ production of a bipolar current collector with one face covered by the anode made of lithium insertion material of the first cell and the opposite face covered by the cathode made of lithium insertion material of the second cell;
b/ production of a first current collector, intended to be adjacent to the bipolar collector one face of which is covered by the cathode of the first cell;
c/ production of a second current collector, intended to be adjacent to the bipolar collector one face of which is covered by the anode of the second cell;
d/ deposition of a bead made of electrically insulating material at the periphery of each face of each collector covered by a cathode or by an anode;
e/ stack of three collectors with intercalation of a separator between two adjacent collectors, the stack with intercalation being performed so that:
the cathode of the adjacent first collector is facing the anode of the bipolar collector being separate from a first separator and with the beads thereof being placed in contact;
the anode of the adjacent second collector is facing the cathode of the bipolar collector being separate from a second separator and with the beads thereof being placed in contact;
f/ heating of the beads in contact at the periphery of the collectors, the separators each being impregnated with an electrolyte.

24. The process as claimed in claim 23, the heating according to step f/ being carried out using U-shaped heating jaws around the peripheral portions of the collectors.

25. The process as claimed in claim 24, the placing in contact of the beads according to step e/ being carried out at ambient temperature.
